(19) United States
(12) Patent Application Publication
(10) Pub. No.: US 2018/0178604 A1
(43) Pub. Date: Jun. 28, 2018

(54) Locking Hitch Pin and Related Methods

(71) Applicant: Lankota Group, Inc., Huron, SD (US)

(72) Inventors: Christopher Opfer, Huron, SD (US); Lance Tschetter, Huron, SD (US)

(21) Appl. No.: 15/850,223

(22) Filed: Dec. 21, 2017

Related U.S. Application Data
(60) Provisional application No. 62/437,401, filed on Dec. 21, 2016.

(51) Int. Cl. B60D 1/28

(52) U.S. Cl. CPC B60D 1/28

(57) ABSTRACT

A hitch pin or other similar type of retention device for maintaining the connection of two pieces of equipment (or a vehicle and a piece of equipment). The retention device has an elongate body and a coupling component that can be removably coupled with the elongate body to help maintain the coupling of the retention device with the equipment.

### CROSS-REFERENCE TO RELATED APPLICATION(S)

This application claims the benefit under 35 U.S.C. § 119(e) to U.S. Provisional Application 62/437,401, filed Dec. 21, 2016 and entitled “Locking Hitch Pin and Related Methods,” which is hereby incorporated herein by reference in its entirety.

### FIELD OF THE INVENTION

The various embodiments herein relate to a retention device for coupling two pieces of equipment that has an elongate body and a removable coupling component that is removably coupleable to the elongate body. In some implementations, the retention device is a hitch pin for coupling a piece of equipment to either a motorized vehicle or another piece of equipment.

### BACKGROUND OF THE INVENTION

A hitch pin is a retention or attachment device for removably coupling a piece of equipment to the hitch of a motorized vehicle such as a truck or a tractor. Typically, once the hitch pin is positioned to couple the equipment to the vehicle, the pin is secured in position with a cotter key or snap pin or similar device or mechanism that is inserted through a hole at a distal end of the pin. For example, FIG. 1A depicts a hitch pin 10 with a cotter key 12 disposed through a hole (not visible) therein, while FIG. 1B depicts another type of hitch pin 14 with a cotter key 16 disposed through a hole (not visible) therein.

In use, a hitch pin is typically used to couple the tongue of the piece of equipment to the hitch of the motorized vehicle, such as a tractor. For example, as shown in FIG. 1C, the tongue 20 is positioned in relation to the hitch 22 of the tractor such that the two holes (not visible in the figure) in the tongue 20 are aligned with the hole (not visible in the figure) in the hitch 22 and the hitch pin 18 is positioned through all three holes by the operator 24, thereby coupling the tongue 20 to the hitch 22. Once the hitch pin 18 is positioned through the three holes and the tongue 20 is coupled to the hitch 22 as desired, a cotter key (not shown) such as those keys 12, 16 discussed above can be inserted through a hole in the distal end of the pin 18, thereby securing the hitch pin 18 in place. Other types of retention devices operate in a similar fashion to couple equipment to motorized vehicles.

It should also be noted that hitch pins and similar coupling devices can also be used to removably couple two non-motorized or non-vehicle pieces of equipment.

One disadvantage of these known retention devices is that they can fail such that the piece of equipment being pulled behind the vehicle can inadvertently uncouple from the vehicle—in some cases while the vehicle and equipment are traveling at a high rate of speed. For example, the typical wear and tear caused by use can result in the cotter key (such as key 12 or 16) easily or inadvertently uncoupling from the pin (such as pin 10 or 14) such that the pin can inadvertently bounce out of or be knocked out of the holes in the tongue and hitch, thereby causing the piece of equipment to suddenly uncouple from the vehicle. Further, the standard cotter key is shaped such that debris and other objects that might come into contact with the key during equipment towing can potentially snag or otherwise couple to the key such that the key can inadvertently be removed from the pin, thereby increasing the risk that the hitch pin will uncouple during use. Alternatively, certain cotter keys (such as key 12 or 16) can be difficult to attach to the pin (such as pin 10 or 14), thereby resulting in the user being less likely to take the time and/or make the effort to couple the key to the pin when not in use, which, in turn, increases the likelihood of the key being lost. The consequence of the difficulty associated with using the cotter is that hitch pins are sometimes used without a cotter key, thereby increasing the chances that any such pin will become inadvertently uncoupled and result in the piece of equipment uncoupling from the vehicle during use.

There is a need in the art for an improved retention device that reduces the likelihood of that device being uncoupled from the equipment to which it is coupled.

### BRIEF SUMMARY OF THE INVENTION

Discussed herein are various hitch pins or other, similar type of retention devices that include an elongate body and a removeably coupleable coupling component or cap.

In Example 1, a retention device comprises an elongate body, a first coupling structure disposed at a distal portion of the elongate body, and a second coupling structure configured to be coupleable with the first coupling structure. The first coupling structure has at least one coupling channel defined in the coupling component, at least one circumferential channel defined in the coupling structure. The second coupling structure has a coupling structure body, a lumen defined in the coupling structure body, at least one projection extending from an inner wall of the lumen, and a force component disposed within the lumen.

Example 2 relates to the retention device according to Example 1, wherein the at least one projection is sized and shaped to be positionable within the at least one coupling channel.

Example 3 relates to the retention device according to Example 1, wherein the elongate body comprises a pin.

Example 4 relates to the retention device according to Example 1, wherein the second coupling structure comprises a cap.

Example 5 relates to the retention device according to Example 1, wherein the force component comprises a spring.

Example 6 relates to the retention device according to Example 1, wherein the at least one coupling channel comprises at least one insertion channel defined in the first coupling structure, at least one circumferential channel defined in the first coupling structure, and at least one locking channel defined in the coupling component. The insertion channel has a longitudinal axis that is parallel with a longitudinal axis of the distal portion of the elongate body; the circumferential channel is in communication with the at least one insertion channel and has an axis that is transverse in relation to the longitudinal axis of the at least one insertion channel; and the at least one locking channel is in communication with the at least one circumferential channel.

Example 7 relates to the retention device according to Example 6, wherein the at least one insertion channel comprises two insertion channels, wherein the at least one locking channel comprises two locking channels, and the at least one projection comprises two projections.

Example 8 relates to the retention device according to Example 1, wherein a distal end of the first coupling structure is in contact with the force component when the first coupling structure is coupled to the second coupling structure.

Example 9 relates to the retention device according to Example 8, wherein the force component is a spring in a tensioned state when the first coupling structure is coupled to the second coupling structure.

In Example 10, a retention device comprises an elongate body, a first coupling component disposed at a distal portion of the elongate body, and a second coupling component configured to be coupleable with the first coupling component. The first coupling component has at least one insertion channel defined in the coupling component, at least one circumferential channel defined in the coupling component, and at least one locking channel defined in the coupling component. The insertion channel has a longitudinal axis that is parallel with a longitudinal axis of the distal portion of the elongate body and the circumferential channel has an axis that is transverse in relation to the longitudinal axis of the at least one insertion channel. The second coupling component has a coupling component body, a lumen defined in the coupling component body, at least one projection extending from an inner wall of the lumen, and a force component disposed within the lumen. The at least one projection is sized and shaped to be positionable within the at least one insertion channel, the at least one circumferential channel, and the at least one locking channel.

Example 11 relates to the retention device according to Example 10, wherein the elongate body comprises a pin and the second coupling component comprises a cap.

Example 12 relates to the retention device according to Example 10, wherein the force component comprises a tension component.

Example 13 relates to the retention device according to Example 10, wherein the at least one insertion channel comprises first and second insertion channels, wherein the at least one locking channel comprises first and second locking channels, and the at least one projection comprises first and second projections.

Example 14 relates to the retention device according to Example 10, wherein a distal end of the first coupling component is in contact with the force component when the first coupling component is coupled to the second coupling component.

Example 15 relates to the retention device according to Example 14, wherein the force component is a spring in a tensioned state when the first coupling component is coupled to the second coupling component such that the spring urges the at least one projection to remain in the at least one locking channel.

In Example 10, a method of coupling a hitch and tongue comprises inserting an elongate body through openings in a hitch of a motorized vehicle and a tongue of a piece of equipment, urging a second coupling component distally toward the first coupling component such that the first coupling component is disposed into a lumen defined in the second coupling component, positioning the second coupling component such that at least one projection extending from an inner wall of the lumen is disposed into the coupling channel of the first coupling component, and rotating the second coupling component in relation to the first coupling component such that the second coupling component lockably attaches to the first coupling component. The elongate body has a first coupling component disposed at a distal portion of the elongate body, and the first coupling component has at least one coupling channel defined in the first coupling component.

Example 17 relates to the method according to Example 16, wherein the urging the second coupling component distally toward the first coupling component further comprises urging the second coupling component into contact with a force component disposed within the lumen such that force applied against the second coupling component by the force component increases as the second coupling component is urged distally into the lumen.

Example 18 relates to the method according to Example 16, wherein the coupling channel comprises, at least one insertion channel defined in the first coupling component, at least one circumferential channel defined in the first coupling component, and at least one locking channel defined in the first coupling component. The insertion channel has a longitudinal axis that is parallel with a longitudinal axis of the distal portion of the elongate body; the circumferential channel is in communication with the at least one insertion channel and has an axis that is transverse in relation to the longitudinal axis of the at least one insertion channel; and the at least one locking channel is in communication with the at least one circumferential channel.

Example 19 relates to the method according to Example 18, wherein the positioning the second coupling component such that the at least one projection is disposed into the coupling channel of the first coupling component further comprises urging the at least one projection into the at least one insertion channel and toward the at least one circumferential channel.

Example 20 relates to the method according to Example 19, wherein the rotating the second coupling component in relation to the first coupling component further comprises rotating the second coupling component when the at least one projection is disposed within the circumferential channel until the at least one projection is aligned with the at least one locking channel, and releasing the second coupling component such that the spring urges the second coupling component proximally such that the at least one projection is urged into the at least one locking channel.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a front view of a known hitch pin.

FIG. 1B is a front view of another known hitch pin.

FIG. 1C is a depiction of a known hitch pin being used to couple a tongue to a hitch of a tractor.

FIG. 2A is a front view of a hitch pin and coupleable cap, according to one embodiment.

FIG. 2B is partially cutaway front view of the hitch pin and coupleable cap of FIG. 2A.

FIG. 3A is a perspective view of a coupleable cap, according to one embodiment.

FIG. 3B is a partially cutaway perspective view of the coupleable cap of FIG. 3A.

FIG. 4A is a perspective view of an elongate body, according to one embodiment.

FIG. 4B is an expanded view of the distal end of the elongate body of FIG. 4A.

FIG. 5A is a perspective view of a coupleable cap and the distal end of an elongate body, according to one embodiment.

FIG. 5B is a perspective view of the coupleable cap of FIG. 5A being positioned over the distal end of the elongate body of FIG. 5A.

FIG. 5C is another perspective view of the coupleable cap and distal end of the elongate body of FIG. 5A in which the cap and body have been rotated in relation to each other.

FIG. 5D is another perspective view of the coupleable cap and distal end of the elongate body of FIG. 5A in which the projections of the cap have been positioned in the locking channels of the elongate body.

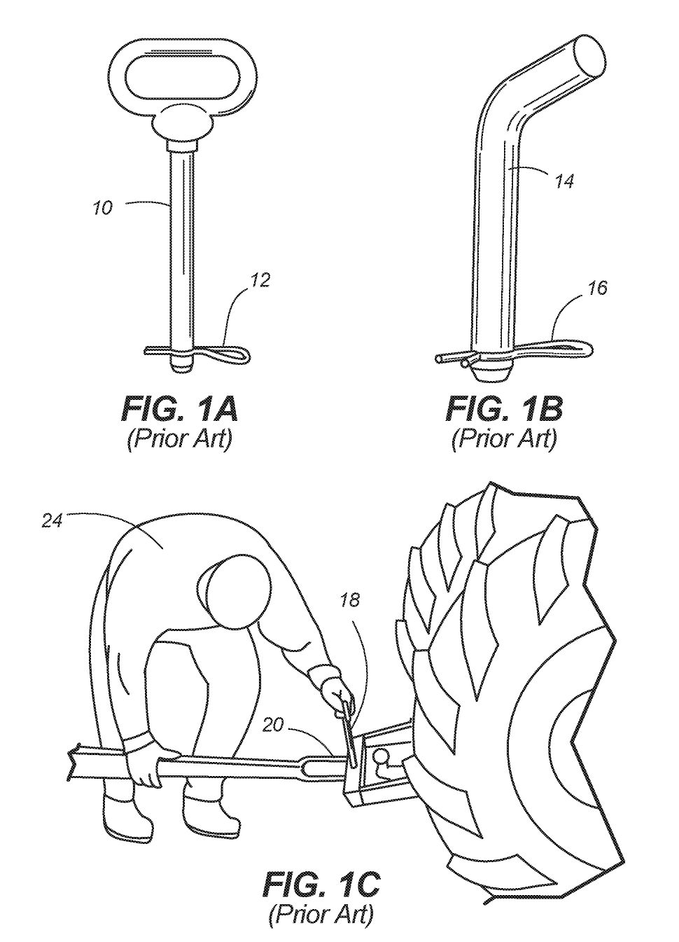

### DETAILED DESCRIPTION

The various embodiments disclosed herein relate to a coupling mechanism (also referred to herein as a “coupling device,” “coupling system,” “retention device,” “retention mechanism,” “retention system,” “attachment system,” “attachment mechanism,” or “attachment device”) such as, for example, a hitch pin, that is rotatably coupleable to a detachable cap. Such a coupling mechanism can be used to couple a vehicle hitch to a piece of equipment to be towed. Alternatively, the coupling mechanism can be used in any known situation or with any known equipment that requires such coupling. For example, the mechanism embodiments as disclosed herein can be utilized in various agricultural equipment such as, for example, tractors and combines, towing equipment (especially receiver hitches), and other industrial uses where the typical cotter key/pin combination might be used.

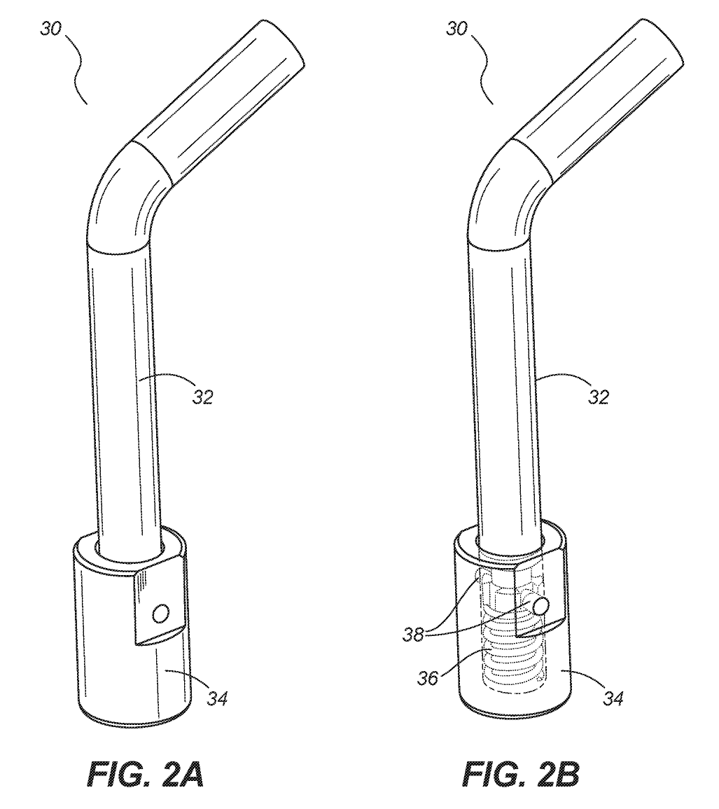

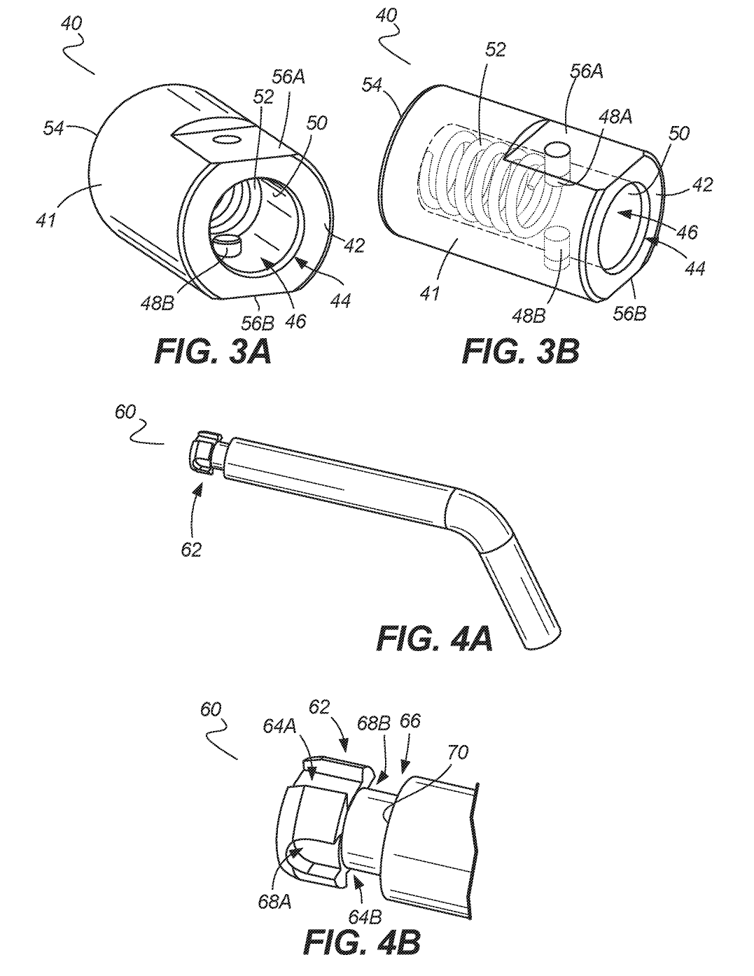

FIGS. 2A and 2B depict the coupling mechanism 30 according to one embodiment in which the mechanism or system 30 has a hitch pin 32 and coupleable cap 34. The cap 34 in FIG. 2B is depicted in broken lines in order to depict some of the inner components of the cap 34, including the force component 36 and the projections 38, as will be described in further detail below with respect to the embodiment depicted in FIGS. 3A and 3B.

One embodiment of a coupleable cap 40 is depicted in FIGS. 3A and 3B. The cap 40 has a body 41 with an opening 44 at a distal end 42 of the cap that provides fluidic access to a lumen 46 defined within the cap 40. Two projections 48A, 48B extend into the lumen 46 such that the longitudinal axes of the two projections are transverse to the longitudinal axis of the cap 40. In this implementation, the two projections 48A, 48B are disposed on opposing sides of the inner wall 50 of the lumen such that the two projections 48A, 48B share the same longitudinal axis or are coaxial. Alternatively, the two projections 48A, 48B can be positioned in other configurations within the lumen 46. In further alternatives, the cap 40 can have one, three, four, or any number of projections that can be positioned within the lumen 46 of the cap 40. It is understood that the term “cap” as used herein is intended to mean any coupleable body that can be removably coupled to the pin such that the combination of the pin and attached cap cannot be removed from the hitch or other attachment structure of a motorized vehicle or other such piece of equipment without first removing the cap from the pin.

The cap 40 also has a force component 52 positioned within the lumen 46. The force component 52 in one embodiment is a spring 52. In a more specific implementation, the spring 52 is a compression spring 52. Alternatively, the force component 52 can be any known force component that can operate to apply the appropriate force to the pin (such as pin 32 described above or pin 60 described below, for example) during use as described herein. In this specific embodiment, the spring 52 is positioned against the proximal end 54 of the body 41 and retained within the lumen 46 by the projections 48A, 48B. That is, the projections 48A, 48B are positioned such that the spring 52 is in contact with at least one of the projections 48A, 48B and cannot move distally past the projections 48A, 48B.

In this implementation, there is no opening in the proximal end 54 of the body 41 and the force component 52 is positioned against that proximal end 54. Alternatively, there can be an opening at the proximal end 54, so long as the cap 40 has some feature at the proximal end 54 that the force component 52 can contact or otherwise be coupled to such that the force component 52 is retained within the lumen 46.

According to one embodiment, the cap body 41 has flat portions 56A, 56B defined or formed along the outer surface of the body 41 at a distal portion of the body 41. Alternatively, the body 41 can have no such flat portions. In a further embodiment, the cap body 41 can have any other known coupling or grasping feature formed in or disposed on the outer surface of the body 41 that makes it easier for a user to grasp and turn the cap body 41 and/or facilitates attachment by any known wrench or other such tool for attaching to and applying force to the cap body 41.

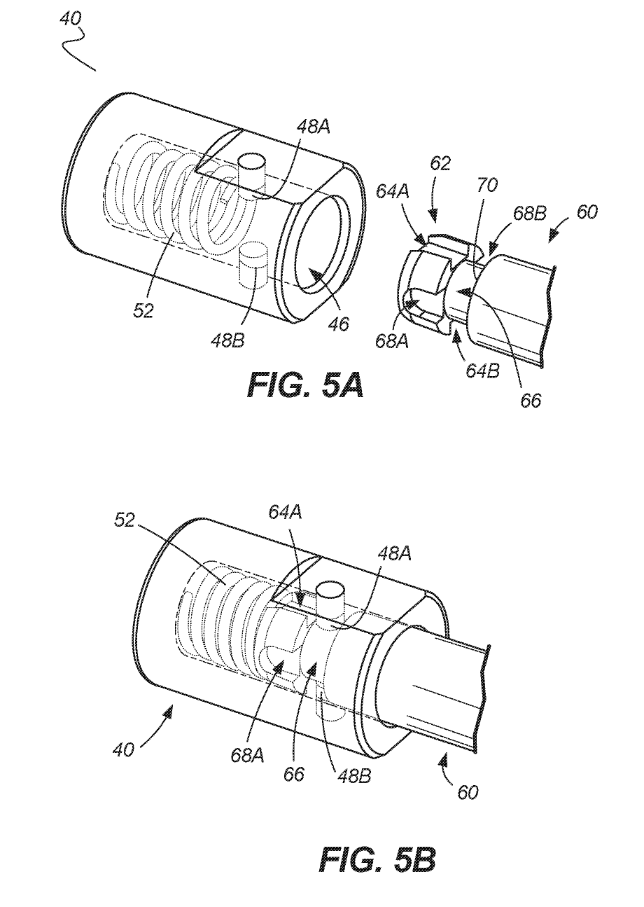

FIGS. 4A and 4B depict a pin 60, according to one embodiment. The pin 60 has a coupling component 62 defined in or attached to a distal portion of the pin 60. The coupling component 62 is a male coupling component (also referred to as a “coupling member,” “coupling head,” or “head”) 62 that is configured to be insertable into the lumen 46 of the cap 40 described above. As best shown in FIG. 4B, the coupling head 62 has two insertion channels 64A, 64B that are configured to receive the two projections 48A, 48B during insertion into the lumen 46. Further, the head 62 also has a circumferential channel 66 that extends around the circumference of the pin 60 such that the projections 48A, 48B can be received in the circumferential channel 66 during insertion of the pin 60 and the pin 60 can be rotated with the projections 48A, 48B so positioned. In addition, the head 62 has two locking channels 68A, 68B that are configured to receive the two projections 48A, 48B such that the projections 48A, 48B are seated therein when the male coupling head 62 is disposed in the locked position in relation to the cap 40. According to one embodiment, the channels 64A, 64B, 66, 68A, 68B are formed in the head 62 by a machining process or any other known process. Alternatively, the channels 64A, 64B, 66, 68A, 68B can be created in any known fashion.

Alternatively, the circumferential channel 66 need not extend around the full 360 degrees of the circumference of the pin 60. Instead, the channel 66 need only provide a path for each projection (such as the two projections 48A, 48B) to move in a rotational fashion from the insertion channel (such as insertion channels 64A, 64B) to the locking channel (such as locking channels 68A, 68B). For example, in those embodiments in which the cap 40 has only one projection, the circumferential channel 66 need only extend from the single insertion channel to the single locking channel. In a further alternative in which the cap 40 has two or more projections, the circumferential channel 66 can be made up of two or more channels (not shown), each of which receives one of the projections and extends solely from one insertion channel to one locking channel.

In one embodiment, the pin 60, head 62, and cap body 41 are made of steel. For example, the pin 60, head 62, and cap body 41 can be made of stainless steel or any other kind of steel. Alternatively, the pin 60, head 62, and cap body 41 can be made of titanium or any other similarly hard and durable material, so long as the material can withstand the amount of force typically applied to a coupling pin. For example, in another embodiment, the pin 60, head 62, and cap body 41 can be made of a hard polymeric composite material. It is understood that the force component 52 can be made of a different material than the rest of the device. For example, in those embodiments in which the force component 52 is a spring 52, the spring 52 can be made of any known material for a spring.

In one implementation, both the cap 40 and the pin 60 are coated with a protective coating to prevent corrosion. In one embodiment, the coating is made of zinc or chrome. Alternatively, any known coating for use in industrial, commercial, or agricultural equipment for preventing corrosion can be used.

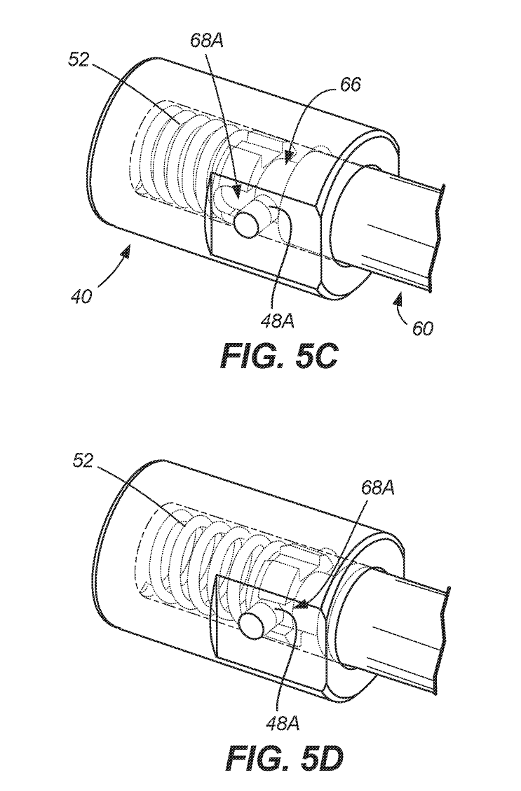

In use, as best shown in FIGS. 5A-5D, the pin 60 can be coupled with the cap 40 in the following manner. With reference to FIG. 5A, the pin 60 and cap 40 are first positioned in relation to each other such that the male coupling head 62 is adjacent to the lumen 46 in the cap 40. Further, the two insertion channels 64A, 64B are aligned with the two projections 48A, 48B such that the projections 48A, 48B can slide through the channels 64A, 64B during insertion.

As best shown in FIG. 5B, the pin 60 is then advanced distally (or the cap 40 is advanced distally, or both) such that the head 62 is inserted into the lumen 46 and the projections 48A, 48B pass through the channels 64A, 64B and are disposed in the circumferential channel 66. That is, the pin 60 and cap 40 are moved in relation to each other until the projections 48A, 48B contact the proximal wall 70 of the circumferential channel 66. As the distal portion of the head 62 advances past the projections 48A, 48B, the head 62 makes contact with the spring 52 and begins to urge the distal end of the spring 52 proximally (in the same the direction that the head 62 is moving), thereby creating additional compression of the spring 52 as shown in FIG. 5B and thus increasing the tension in the spring 52. Hence, as the user advances the pin 60 into the cap 40 (or the cap 40 onto the pin 60), an increasing opposing force is applied by the spring 52 and the user must apply sufficient force to overcome the opposing force of the spring 52 in order to advance the pin 60 in relation to the cap 40.

Once the head 62 has been advanced a sufficient distance in relation to the cap 40 such that the projections 48A, 48B are positioned in the circumferential channel 66 as discussed above (and thus the opposing force of the spring 52 is greater than when it is in an untensioned state), the operator rotates the cap 40 in relation to the pin 60 as shown in FIG. 5C (or the pin 60 is rotated in relation to the cap 40) such that the projection 48A is moved along the circumferential channel 66 until it is aligned with locking channel 68A (and projection 48B is aligned with locking channel 68B, which are not visible in FIG. 5C).

The operator can then release the cap 40 and/or pin 60 or otherwise stop applying force thereto such that the opposing force of the spring 52 urges the pin 60 proximally in relation to the cap 40, thereby resulting in the head 62 moving proximally and the projections 48A, 48B being positioned in the locking channels 68A, 68B as best shown in FIG. 5D. As such, the spring 52 causes the cap 40 to “snap” into the locked position. With the spring 52 positioned to urge the head 62 proximally, the spring 52 helps to retain the head 62 in position such that the projections 48A, 48B are positioned in the locking channels 68A, 68B, thereby assisting with maintaining the cap 40 in a locked position on the pin 60. As such, unlocking the cap 40 from the pin 60 can only occur by applying an appropriate amount of distal force to the cap 40 in relation to the pin 60 (or the pin 60 in relation to the cap 40) while also applying a rotating force as well.

The rotatable, detachable cap according to the various embodiments disclosed or contemplated herein is an improvement over a cotter key, because the cap eliminates the risk of any debris causing the detachment of the cap from the hitch pin. That is, the cap has few or no physical features that could cause the cap to be inadvertently removed from or otherwise uncouple from the pin without the required human input described above. However, despite the secure nature of the locking mechanism provided by the cap and pin embodiments described above, the mechanism also provides for quick and easy removal of the cap. Further, in contrast to cotter keys and other such mechanisms, the cap and pin configurations disclosed herein are not only more secure, but also result in a decreased likelihood of a looser coupling over time due to wear and tear.

Although the present invention has been described with reference to preferred embodiments, persons skilled in the art will recognize that changes may be made in form and detail without departing from the spirit and scope of the invention.

What is claimed is:

1. A retention device comprising:
(a) an elongate body;
(b) a first coupling structure disposed at a distal portion of the elongate body, the first coupling structure comprising at least one coupling channel defined in the coupling structure;
and
(c) a second coupling structure configured to be coupleable with the first coupling structure, the second coupling structure comprising:
(i) a coupling structure body;
(ii) a lumen defined in the coupling structure body;
(iii) at least one projection extending from an inner wall of the lumen; and
(iv) a force component disposed within the lumen.

2. The retention device of claim 1, wherein the at least one projection is sized and shaped to be positionable within the at least one coupling channel.

3. The retention device of claim 1, wherein the elongate body comprises a pin.

4. The retention device of claim 1, wherein the second coupling structure comprises a cap.

5. The retention device of claim 1, wherein the force component comprises a spring.

6. The retention device of claim 1, wherein the at least one coupling channel comprises:
(a) at least one insertion channel defined in the first coupling structure, wherein the insertion channel has a longitudinal axis that is parallel with a longitudinal axis of the distal portion of the elongate body;
(b) at least one circumferential channel defined in the first coupling structure, wherein the circumferential channel is in communication with the at least one insertion channel and has an axis that is transverse in relation to the longitudinal axis of the at least one insertion channel; and
(c) at least one locking channel defined in the coupling component, wherein the at least one locking channel is in communication with the at least one circumferential channel.

7. The retention device of claim 6, wherein the at least one insertion channel comprises two insertion channels, wherein the at least one locking channel comprises two locking channels, and the at least one projection comprises two projections.

8. The retention device of claim 1, wherein a distal end of the first coupling structure is in contact with the force component when the first coupling structure is coupled to the second coupling structure.

9. The retention device of claim 8, wherein the force component is a spring in a tensioned state when the first coupling structure is coupled to the second coupling structure.

10. A retention device comprising:
(a) an elongate body;
(b) a first coupling component disposed at a distal portion of the elongate body, the first coupling component comprising:
(i) at least one insertion channel defined in the coupling component, wherein the insertion channel has a longitudinal axis that is parallel with a longitudinal axis of the distal portion of the elongate body;
(ii) at least one circumferential channel defined in the coupling component, wherein the circumferential channel has an axis that is transverse in relation to the longitudinal axis of the at least one insertion channel; and
(iii) at least one locking channel defined in the coupling component; and
(c) a second coupling component configured to be coupleable with the first coupling component, the second coupling component comprising:
(i) a coupling component body;
(ii) a lumen defined in the coupling component body;
(iii) at least one projection extending from an inner wall of the lumen, wherein the at least one projection is sized and shaped to be positionable within the at least one insertion channel, the at least one circumferential channel, and the at least one locking channel; and
(iv) a force component disposed within the lumen.

11. The retention device of claim 10, wherein the elongate body comprises a pin and the second coupling component comprises a cap.

12. The retention device of claim 10, wherein the force component comprises a tension component.

13. The retention device of claim 10, wherein the at least one insertion channel comprises first and second insertion channels, wherein the at least one locking channel comprises first and second locking channels, and the at least one projection comprises first and second projections.

14. The retention device of claim 10, wherein a distal end of the first coupling component is in contact with the force component when the first coupling component is coupled to the second coupling component.

15. The retention device of claim 14, wherein the force component is a spring in a tensioned state when the first coupling component is coupled to the second coupling component such that the spring urges the at least one projection to remain in the at least one locking channel.

16. A method of coupling a hitch and tongue, the method comprising:
inserting an elongate body through openings in a hitch of a motorized vehicle and a tongue of a piece of equipment, wherein the elongate body comprises a first coupling component disposed at a distal portion of the elongate body, the first coupling component comprising at least one coupling channel defined in the first coupling component;
urging a second coupling component distally toward the first coupling component such that the first coupling component is disposed into a lumen defined in the second coupling component;
positioning the second coupling component such that at least one projection extending from an inner wall of the lumen is disposed into the coupling channel of the first coupling component; and
rotating the second coupling component in relation to the first coupling component such that the second coupling component lockably attaches to the first coupling component.

17. The method of claim 16, wherein the urging the second coupling component distally toward the first coupling component further comprises urging the second coupling component into contact with a force component disposed within the lumen such that force applied against the second coupling component by the force component increases as the second coupling component is urged distally into the lumen.

18. The method of claim 16, wherein the coupling channel comprises:
(a) at least one insertion channel defined in the first coupling component, wherein the insertion channel has a longitudinal axis that is parallel with a longitudinal axis of the distal portion of the elongate body;
(b) at least one circumferential channel defined in the first coupling component, wherein the circumferential channel is in communication with the at least one insertion channel and has an axis that is transverse in relation to the longitudinal axis of the at least one insertion channel; and
(c) at least one locking channel defined in the first coupling component, wherein the at least one locking channel is in communication with the at least one circumferential channel.

19. The method of claim 18, wherein the positioning the second coupling component such that the at least one projection is disposed into the coupling channel of the first coupling component further comprises urging the at least one projection into the at least one insertion channel and toward the at least one circumferential channel.

20. The method of claim 19, wherein the rotating the second coupling component in relation to the first coupling component further comprises:
rotating the second coupling component when the at least one projection is disposed within the circumferential channel until the at least one projection is aligned with the at least one locking channel; and
releasing the second coupling component such that the spring urges the second coupling component proximally such that the at least one projection is urged into the at least one locking channel.
